(19) United States
(12) Patent Application Publication
(10) Pub. No.: US 2013/0032633 A1
(43) Pub. Date: Feb. 7, 2013

(54) CHIP TEST SYSTEM

(71) Applicants: YING-BIN FU, Shenzhen City (CN); LAN-YI FENG, Shenzhen City (CN); YA-JUN PAN, Shenzhen City (CN)

(72) Inventors: YING-BIN FU, Shenzhen City (CN); LAN-YI FENG, Shenzhen City (CN); YA-JUN PAN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/305,047

(22) Filed: Nov. 28, 2011

(30) Foreign Application Priority Data
Aug. 5, 2011 (CN) 201110223541.7

(51) Int. Cl. G06F 17/00

(52) U.S. Cl. 235/375

(57) ABSTRACT

A chip test system includes a digital control chip, a controller, and an indication circuit. A configuration file is burned into the digital control chip. The configuration file includes a first identification number. The controller reads the number from the configuration file and determines whether the number is the same as a predetermined identification number. If the numbers match, the controller outputs a first level signal to the indication circuit. If the numbers do not match, the controller outputs a second level signal to the indication circuit.

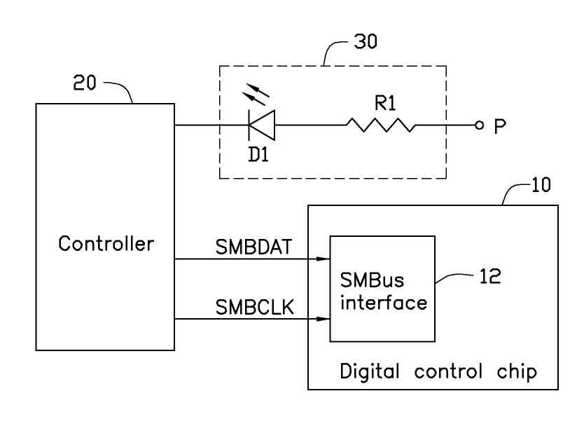

### TECHNICAL FIELD

The present disclosure relates to detection systems, and particularly, to a chip test system.

### DESCRIPTION OF RELATED ART

Many digital control chips are integrated in motherboards. For example, a digital control chip is used to supply power for a central processing unit (CPU) of a motherboard. In using the digital control chip, a computer is applied to burn a configuration file to the digital control chip. For different types of motherboards, the configuration files burned into the digital control chip mounted on the different types of motherboards are different, and it is difficult to determine whether the configuration file burned into the corresponding digital control chip is correct.

### BRIEF DESCRIPTION OF THE DRAWING

Many aspects of the present embodiments can be better understood with reference to the following drawing. The components in the drawing are not necessarily drawn to scale, the emphasis instead being placed upon clearly illustrating the principles of the present disclosure. Moreover, in the drawings, all the views are schematic, and like reference numerals designate corresponding parts throughout the several views.

The figure is a circuit diagram of an exemplary embodiment of a chip test system.

### DETAILED DESCRIPTION

The disclosure, including the accompanying drawing in which like references indicate similar elements, is illustrated by way of example and not by way of limitation. It should be noted that references to “an” or “one” embodiment in this disclosure are not necessarily to the same embodiment, and such references mean at least one.

Referring to the figure, an embodiment of a chip test system includes a digital control chip 10, a controller 20, and an indication circuit 30. A configuration file is burned into the digital control chip 10. The configuration file includes a first identification number. The controller 20 is connected to the indication circuit 30. In the embodiment, the digital control chip 10 is a digital pulse control chip. The digital control chip 10 includes a system management bus (SMBus) interface 12. The controller 20 is connected to the SMBus interface 12 through a data signal line SMBDAT and a clock signal line SMBCLK. The controller 20 is an integrated baseboard management controller (IBMC).

The indication circuit 30 includes a light emitting diode (LED) D1 and a resistor R1. A cathode of the LED D1 is connected to the controller 20. An anode of the LED D1 is connected to a power source P through the resistor R1.

In designing a motherboard, a computer is needed to debug a digital control chip mounted on the motherboard. After debugging the digital control chip, the computer generates a configuration file of the designed motherboard. A first identification number is written to the configuration file. Each type of motherboards will have a unique identification number.

Before determining whether the configuration file burned into the digital control chip 10 is correct, users identify the identification number of the motherboard, and controls the computer to write the identification number to the controller 20. The written identification number functions as a predetermined identification number for matching to the digital control chip. In testing, the controller 20 reads the first identification number of the configuration file burned into the digital control chip 10, and determines whether the read first identification number is the same as the predetermined identification number. If the read first identification number is the same as the predetermined identification number, the controller 20 outputs a logic 0 (low level) signal to the indication circuit 30. The LED D1 emits light, which indicates that the configuration file burned into the digital control chip 10 is correct is the correct file. If the read first identification number is different than the predetermined identification number, the controller 20 outputs a logic 1 (high level) signal to the indication circuit 30. The LED D1 fails to emit light, which indicates that the configuration file burned into the digital control chip 10 is not the correct file. Then the correct configuration file can be burned into the digital control chip 10.

Although numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the embodiments to the full extent indicated by the broad general meaning of the terms in which the appended claims are expressed.

1. A chip test system comprising:
a digital control chip, wherein a configuration file is burned into the digital control chip, the configuration file comprises a first identification number indicating one type of motherboards;
a controller connected to the digital control chip to read the first identification number from the configuration file burned into the digital control chip, and to determine whether the read first identification number is the same as a predetermined identification number corresponding to one type of motherboards that the digital control chip is to be arranged on, wherein if the read first identification number is the same as the predetermined identification number, the controller outputs a first level signal, if the read first identification number is different from the predetermined identification number, the controller outputs a second level signal; and
an indication circuit connected to the controller to receive the first or second level signal, and to give different indications according to the first and second level signals.

2. The chip test system of claim 1, wherein the indication circuit comprises a light emitting diode (LED) and a resistor, an anode of the LED is connected to a power source through the resistor, a cathode of the LED is connected to the controller, when the indication circuit receives the first level signal, the LED emits light, when the indication circuit receives the second level signal, the LED fails to emit light.

3. The chip test system of claim 1, wherein the controller is an integrated baseboard management controller.

4. The chip test system of claim 1, wherein the digital control chip comprises a system management bus (SMBus) interface connected to the controller.

5. The chip test system of claim 4, wherein the controller is connected to the SMBus interface through a data signal line and a clock signal line.

6. A chip test method comprising:
burning a configuration file into a digital control chip, wherein the configuration file comprises a first identification number indicating one type of motherboards;
reading the first identification number for the configuration file by a controller;
determining whether the read first identification number is the same as a predetermined identification number corresponding to one type of motherboards that the digital control chip is to be arranged on;
outputting a first level signal in respond to the read first identification number is different from the predetermined identification number by the controller; and
giving a first indication by an indication circuit in respond to receiving the first level signal.

7. The chip test method of claim 6, further comprising:
outputting a second level signal in respond to the read first identification number is the same as the predetermined identification number by the controller; and
giving a second indication by the indication circuit in respond to receiving the second level signal.

8. The chip test method of claim 7, wherein the indication circuit comprises a light emitting diode (LED) and a resistor, an anode of the LED is connected to a power source through the resistor, a cathode of the LED is connected to the controller, when the indication circuit receives the first level signal, the LED emits light, when the indication circuit receives the second level signal, the LED fails to emit light.

9. The chip test method of claim 6, wherein the controller is an integrated baseboard management controller.

10. The chip test method of claim 6, wherein the controller is connected to the SMBus interface through a data signal line and a clock signal line.
